(19) United States
(12) Patent Application Publication
(10) Pub. No.: US 2023/0261215 A1
(43) Pub. Date: Aug. 17, 2023

(54) FUEL CELL ANODE OFF GAS RECIRCULATION SYSTEM AND METHOD USING MULTIPLE EJECTORS TO ENABLE VARIABLE FLOW

(71) Applicant: Cummins Inc., Columbus, IN (US)

(72) Inventors: John Robert PENDRAY, Blaine, MN (US); Charles J. VESELY, Andover, MN (US); Scott Patrick BEARD, Cedar, MN (US)

(21) Appl. No.: 17/670,263

(22) Filed: Feb. 11, 2022

(51) Int. Cl. H01M 8/04089; H01M 8/04746

(52) U.S. Cl. CPC H01M 8/04097; H01M 8/04761

(57) ABSTRACT

A method and system for recirculating an anode off gas in a fuel cell assembly includes receiving anode off gas and generating steam therefrom. A first flow of the steam is directed to a first control valve and a second flow of the steam is directed to a second control valve. The first and second control valves control steam that flows through the superheater and connects to a first ejector and a second ejector. In response to an operating parameter being equal to a threshold value, the first control valve is opened to allow the steam to pass through the superheater and subsequently at least partially drive the first ejector.

### TECHNICAL FIELD

The present disclosure generally relates to systems and methods for anode off gas recirculation in a fuel cell.

### BACKGROUND

A fuel cell is an electrochemical energy conversion device used in power generation. A fuel cell includes two electrodes and an electrolyte disposed between them. During operation, electrochemical reactions occur in the fuel cell to convert fuel and oxygen (oxidant) into water or steam (byproduct) and generate electricity. Typically, the electrochemical reactions occur at the electrodes where a catalyst is often disposed to speed up such reactions. The electrodes provide an increased surface area for the electrochemical reactions to occur.

The electrolyte transfers electrically charged particles from one electrode to the other electrode and is otherwise substantially impermeable to both the fuel and the oxidant. The byproducts may exit the fuel cell at high operating temperature. The fuel cell system may include a reformer for reforming hydrocarbon fuels by using the byproducts of the fuel cell to produce a reformed stream that may then be circulated to the fuel cell to further improve the efficiency of the fuel cell. The present disclosure is directed to improved systems and methods for recirculating anode off gas to a fuel cell using multiple ejectors to enable variable flow.

### SUMMARY

A method for recirculating an anode off gas in a fuel cell assembly according to the present disclosure includes receiving, at a flow splitter, the anode off gas from an anode of a fuel cell, directing, at the flow splitter, a first portion of the received anode off gas to a superheater, and superheating at the superheater, the first portion of the anode off gas and directing at least a portion of the superheated first portion to a boiler.

The method further includes controlling a first flow of steam from the boiler through the superheater using a first control valve arranged between the boiler and the superheater and controlling a second flow of steam from the boiler through the superheater using a second control valve arranged between the boiler and the superheater, wherein the first control valve fluidically connects the boiler to a first ejector downstream of the superheater, and wherein the second control valve fluidically connects the boiler to a second ejector downstream of the superheater. In response to a value of an operating parameter being equal to a first threshold value, opening the first control valve to allow the first flow of steam to pass through the superheater and subsequently at least partially drive the first ejector.

In some embodiments, the method further includes, in response to the value of the operating parameter being equal to a second threshold value, closing the first control valve to prevent the first flow of steam from passing through the superheater and at least partially driving the first ejector, and opening the second control valve to allow the second flow of steam to pass through the superheater to at least partially drive the second ejector.

In some embodiments, the first ejector has a first size and the second ejector has a second size, wherein the first and second sizes are defined as a maximum capacity of a first amount of steam and second amount of anode off gas of the first and second ejectors, and wherein the second size is at least twice the first size.

In some embodiments, the second threshold value is equal to the first threshold value. In some embodiments, the operating parameter is an average pressure of the generated steam, and the first threshold value and the second threshold value are approximately 7.8 bar. In some embodiments, the first control valve and the second control valve are electrically controlled solenoid valves.

In at least one embodiment, the method further includes directing, at the flow splitter, a second portion of the received anode off gas to the first ejector, preventing the second portion of the received anode off gas from flowing back toward the flow splitter via a first check valve arranged between the first ejector and the flow splitter, directing, at the flow splitter, a third portion of the received anode off gas to the second ejector, and preventing the third portion of the received anode off gas from flowing back toward the flow splitter via a second check valve arranged between the second ejector and the flow splitter.

In some embodiments, the first flow of steam enters the superheater via a first input end of a first conduit of the superheater, increases in temperature within the superheater, exits via a first output end of the first conduit, and subsequently drives the first ejector. The second flow of steam further enters the superheater via a second input end of a second conduit of the superheater, increases in temperature within the superheater, exits via a second output end of the second conduit, and subsequently drives the second ejector. In some embodiments, an entrainment ratio remains above 3.5 in response to the first ejector and the second ejector operating at or above a 22% load.

In some embodiments, the method further includes, in response to the value of the operating parameter being equal to a third threshold value, opening the first control valve to allow the steam to pass through the superheater to at least partially drive the first ejector, and keeping open the second control valve to allow the steam to also pass through the superheater to at least partially drive the second ejector. In some embodiments, the third threshold value is equal to the second threshold value and the first threshold value.

A method for recirculating an anode off gas in a fuel cell assembly according to a further aspect of the present disclosure includes superheating at least a portion of steam in the anode off gas in a superheater, and in response to a value of an operating parameter being equal to a threshold value, opening a control valve configured to control a flow of steam from a boiler through the superheater to at least partially drive an ejector fluidically between the superheater and a fuel cell.

In some embodiments, the threshold value is a first threshold value, the control valve is a first control valve, the ejector is a first ejector. The method further includes, in response to the value of the operating parameter being equal to a second threshold value, closing the first control valve to prevent the steam from passing through the superheater and at least partially driving the first ejector, and opening a second control valve arranged upstream of the superheater to allow the steam to pass through the superheater to at least partially drive a second ejector fluidically between the superheater and a fuel cell.

In some embodiments, the first ejector has a first size and the second ejector has a second size, wherein the first and second sizes are defined as a maximum capacity of a first amount of steam and second amount of anode off gas of the first and second ejectors, and wherein the second size is at least twice the first size. In some embodiments, the method further includes, in response to the value of the operating parameter being equal to a third threshold value, opening the first control valve to allow the steam to pass through the superheater and at least partially drive the first ejector, and keeping open the second control valve to allow the steam to also pass through the superheater and at least partially drive the second ejector.

A recirculation system for a fuel cell assembly according to a further aspect of the present disclosure includes a flow splitter, a superheater, a boiler, a plurality of ejectors, and a plurality of control valves. The flow splitter is operably coupled to an anode of the fuel cell and configured to receive an anode off gas therefrom. The superheater is disposed downstream from the flow splitter and configured to regulate a first portion of the anode off gas received through the flow splitter. The boiler is operably coupled to the superheater and configured to receive the first portion of the anode off gas, the boiler further configured to generate steam and direct at least a portion of the steam toward the superheater.

In some embodiments, the plurality of ejectors includes a first ejector and a second ejector, the first ejector arranged downstream of the superheater, the first ejector configured to be driven at least partially by a first flow of steam of the generated steam from the superheater, the second ejector arranged downstream of the superheater, the second ejector configured to be driven at least partially by a second flow of steam of the generated steam from the superheater. The plurality of control valves includes a first control valve and a second control valve, the first control valve arranged between the boiler and the superheater, the first control valve configured to open so as to allow the first flow of steam to pass through the superheater and configured to close so as to prevent the first flow of steam from passing through the superheater, the second control valve configured to open so as to allow the second flow of steam to pass through the superheater and configured to close so as to prevent the second flow of steam from passing through the superheater.

In some embodiments, in response to a value of an operating parameter being equal to a first threshold value, the first control valve is configured to open so as to allow the first flow of steam to pass through the superheater to at least partially drive the first ejector.

In some embodiments, in response to the value of the operating parameter being equal to a second threshold value, closing the first control valve to prevent the first flow of steam from passing through the superheater and at least partially driving the first ejector, and opening the second control valve to allow the second flow of steam to pass through the superheater to at least partially drive the second ejector.

In some embodiments, the first ejector has a first size and the second ejector has a second size, wherein the first and second sizes are defined as a maximum capacity of a first amount of generated steam and second amount of anode off gas of the first and second ejectors, and wherein the second size is at least twice the first size.

In some embodiments, in response to the value of the operating parameter being equal to a third threshold value, opening the first control valve to allow the first flow of steam to pass through the superheater to at least partially drive the first ejector, and keeping open the second control valve to allow the second flow of steam to also pass through the superheater to at least partially drive the second ejector. In some embodiments, an entrainment ratio remains above 3.5 in response to the first ejector and the second ejector operating at or above a 22% load.

### BRIEF DESCRIPTION OF THE DRAWINGS

The detailed description particularly refers to the following figures, in which:

FIG. 1 is a block diagram illustrating an embodiment of an anode off gas recirculation system;

FIG. 2 is a block diagram illustrating example ejector arrangements for the anode off gas recirculation system of FIG. 1;

FIG. 3 is a graph showing load of the system versus entrainment ratio of the system for different ejector arrangements of the present disclosure;

FIG. 4 is a block diagram illustrating further exemplary ejector arrangements for the recirculation system of FIG. 1; and

FIG. 5 is a block diagram illustrating example process flows for the recirculation system and ejector arrangements of FIGS. 1-4.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features as further described herein.

While the concepts of the present disclosure are susceptible to various modifications and alternative forms, specific exemplary embodiments have been shown by way of example in the drawings and will be described. It should be understood, however, that there is no intent to limit the concepts of the present disclosure to the particular forms disclosed. On the contrary, the intention is to cover all modifications, equivalents, and alternatives falling within the spirit and scope of the invention as defined by the appended claims.

### DETAILED DESCRIPTION

The present disclosure is directed to improved systems and methods for recirculating anode off gas to a fuel cell system and/or a fuel cell. Those skilled in the art will understand that the various embodiments of anode off gas recirculation systems and methods related to those systems specifically described herein and illustrated in the accompanying drawings are non-limiting exemplary embodiments and that the scope of the present disclosure is defined solely by the claims. One of ordinary skill in the art would understand that the various embodiments of anode off gas recirculation systems and methods related to those systems would apply to various types of fuel cells known in the art.

Fuel cells of the present system and methods include phosphoric acid fuel cell (PAFC), molten carbonate fuel cell (MCFC), proton exchange membrane fuel cell (PEMFC), anion exchange membrane fuel cell (AEMFC), and solid oxide fuel cell (SOFC). Fuel cells, such as SOFCs, may operate in large-scale power generation systems to satisfy industrial and municipal needs. Other types of fuel cells (e.g., PEMFCs) may be useful for smaller portable applications such as, for example, powering vehicles. While this disclosure is related to all types of fuel cells, exemplary fuel cells of the present system and methods are proton exchange membrane fuel cell (PEMFC) and/or solid oxide fuel cell (SOFC). In at least some of the embodiments disclosed herein, the system and/or method specifically includes a solid oxide fuel cell (SOFC).

An anode off gas recirculation system 100 of a fuel cell system 104 (e.g., fuel cell stack, fuel cell module, etc.) including at least a cathode 107 and an anode 110 according to the present disclosure may include a motive force. The motive force is able to drive recirculation and flow of the anode off gas 109. The motive force may be provided by an anode off gas recirculation blower, one or more types of ejectors, or some combination of one or more blowers and one or more ejector types or systems. For example, types or systems of ejectors may comprise fuel-driven ejectors, steam-driven ejectors, and/or combinations thereof.

In practice, some recirculation motive force solutions are more efficient and cost-effective than others. For example, a blower used to recirculate anode off gas through the fuel cell requires cooling and recuperation of the anode off gas recirculation gases. The cooling and recuperation of the gases by the blower adds cost and may, in some cases, reduce overall energy efficiency of the fuel cell system (e.g., a SOFC system). As another example, fuel-driven ejectors, while moderate in cost, require high fuel pressure and may be unable to provide sufficient off gas recirculation rates. Accordingly, illustrative examples of the present system and methods comprise steam-driven ejectors.

A portion of the anode off gas 109 that is not recirculated (e.g., an anode gas recirculation 111) is referred to as an anode off gas slip stream 113. The anode off gas slip stream 113 may be mixed with a cathode off gas and oxidized in a catalyst. Some steam-driven ejectors may rely on the anode off gas recirculation 111, rather than on the slip gas 113, for sufficient water supply. Therefore, those same steam-driven ejectors may consume a substantial amount of energy, cause an increased pressure loss in the system, or both.

The systems and methods (e.g., the system 100), as discussed herein, comprise an improved steam-driven ejector system 114 comprising one or multiple ejectors. In particular, the present system 100 includes an ejector system 114 including a plurality of ejectors. At least one exemplary embodiment described herein includes two ejectors 202, 204. A further exemplary embodiment described herein includes three ejectors 302, 304, 306. Additional exemplary embodiments may include four, five, six, or more ejectors based on the requirements of the system 100 as would be appreciated by one of ordinary skill in the art.

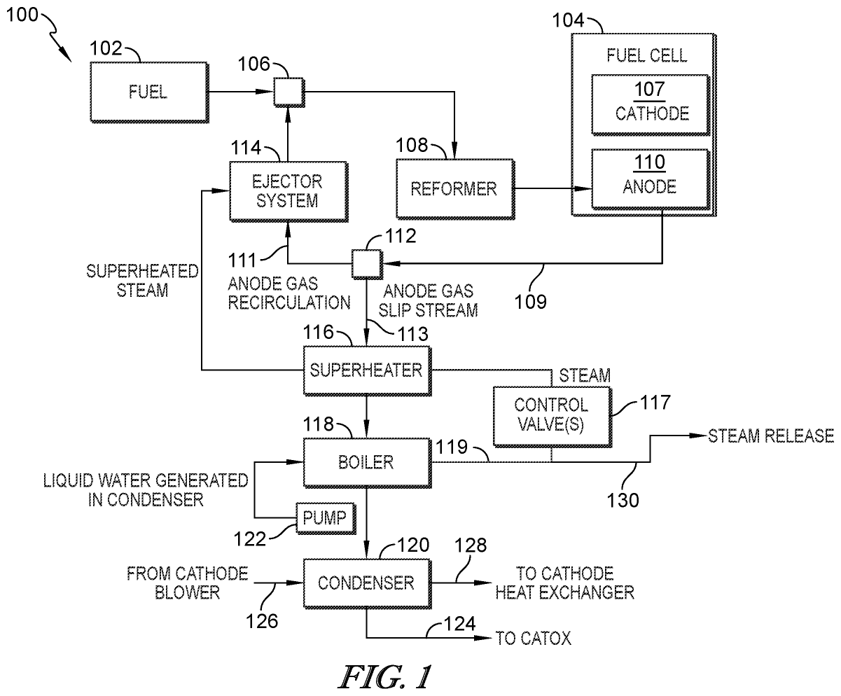

Referring now to FIG. 1, an anode off gas recirculation system 100 of the present disclosure includes a superheater 116 disposed before or upstream from a boiler 118. The boiler 118 is configured to extract thermal energy from the anode off gas slip stream 113 before the off gas 109 is directed into the boiler 118 and/or a condenser 120. The superheater 116 is configured to establish thermodynamically favorable conditions, such as for a steam-driven ejector system 114 of system 100 to take advantage of thermal energy abundant in the anode off gas slip stream 113.

The superheater 116 also protects the boiler 118 from excessive boiling by ensuring that the amount of thermal energy in the anode off gas slip stream 113 does not exceed a predefined threshold. As such, the superheater 116 regulates the thermal energy with respect to the amount of water available in the boiler 118 foregoing the need for an external water supply if the slip gas 113 moisture is sufficiently captured in the condenser 120. Therefore, in exemplary embodiments of the present system, an external water supply is not needed and/or required. Eliminating an external water supply provides numerous advantages, such as reducing the size (e.g., volume) and weight of the fuel cell system which is useful for both stationary power generation and mobile power generation (e.g., FC powered vehicles), reducing the complexity of the balance of plant supporting the fuel cell stack, and/or allowing more flexibility in locating some systems such as where water is less available.

As previously mentioned, the anode off gas recirculation system 100 includes the steam-driven ejector system 114 having one or more steam-driven ejectors. Each steam-driven ejector is configured to selectively engage or disengage based on a value of one or more system 100 operating parameters. For example, operating parameters of the anode system off gas recirculation system 100 may include, but are not limited to pressure, system power, system voltage, fuel flow rate, and/or steam flow rate.

For implementations of the recirculation system 100 having two or more ejectors, the ejectors may be of the same size, a different size, or some combination thereof with respect to one another. In one example, size of a given ejector comprises a combination of a first amount of steam input to drive the ejector and a second amount of anode gas supply for induction into the ejector. As such, size of the ejector bears on a gas/steam output of that ejector as affected by a combination of the first steam amount and the second anode gas amount (i.e., a combined input amount).

In some instances, an absolute value of the combined input amount to drive the ejectors of the ejector system 114 corresponds to the physical size and/or capacity of that ejector. In other words, an ejector having a larger combined input amount and/or a larger output amount may be physically larger than an ejector associated with a smaller combined input amount and/or a smaller output amount. Implementing ejectors of different sizes allows the amount of steam to vary proportionally with the amount of fuel. This multi-ejector configuration enables a passively adaptive system 100 and process to generate sufficient anode off gas recirculation rates in order to accommodate changes in fuel flow.

FIG. 1 illustrates an example system 100 for recirculating an anode off gas 109, such as for use in a fuel cell assembly 104. As shown, the system 100 includes a fuel source 102 that provides fuel, e.g., hydrocarbon and/or hydrogen, to a reformer 108 via a fuel mixer 106. The reformer 108 is configured to break down complex hydrocarbons present in the fuel/steam mixture stream or flow and may increase calorific value of the fuel/steam mixture.

In some examples, a heat exchanger (not shown), such as a high temperature heat exchanger, may be disposed between the reformer 108 and the anode 110. The heat exchanger is configured to regulate a temperature (e.g., heat) of input fuel and recirculated anode off gas received from the fuel mixer 106 to generate a higher energy fuel-rich steam stream prior to outputting and/or directing the steam stream to the reformer 108. This heat exchanger derives its thermal energy from the anode 110 outlet before a flow splitter 112.

The reformer 108 outputs hydrogen-rich gas (reformate) stream to an anode 110 of a fuel cell or a fuel cell assembly (e.g., fuel cell system, fuel cell stack, etc.) 104. The anode 110 is where hydrogen is oxidized producing electric energy and water. Anode off gas 109 exiting the anode 110 of the fuel cell enters a downstream flow splitter 112 that is operably coupled to an ejector system 114 and a superheater 116.

The flow splitter 112 is configured to split or divide the anode off gas 109 stream into a first portion 111 and a second portion 113. The flow splitter 112 routes the first portion of the anode off gas 109, i.e., the anode recirculation gas 111, to the ejector system 114. The flow splitter 112 routes the routes the second portion, i.e., the anode slip stream 113, to the superheater 116.

In the illustrative embodiment, the ejectors of the ejector system 114 are steam-driven and connect to the fuel mixer 106. The ejector system 114 causes the anode recirculation gas 111 to be mixed, via the fuel mixer 106, with the input fuel stream directed to the reformer 108 and then to the inlet of the anode 110.

The superheater 116 receives, from the flow splitter 112, the second portion 113 of the anode off gas 109, the anode slip stream 113. The superheater 116 is configured to regulate a thermal energy and a temperature of the slip stream 113 before the slip stream 113 enters the boiler 118. The superheater 116 takes heat from the slip stream 113 to superheat steam (e.g., entrained therein) to give the steam more energy (e.g., thermal energy), because the anode off gas 109 exits the anode 110 at an elevated temperature (such as, for example, greater than 600° C.) compared to an operating temperature of the boiler 118 (which can, for example, be around 200° C.). Thus, the superheater 116 recovers heat from the stream 113 to superheat steam in the flow to generate more power in the downstream boiler 118. The superheater 116 directs, for example, a cooler slip stream (relative to the temperature of the stream exiting the anode) to the boiler 118 that, in turn, generates steam. At least a portion of the steam is directed back to the superheater 116 via at least one line 119. The term “line” as referred to herein includes any type of fluidic connection component, such as a tube, pipe, hose, and the like.

At least one control valve 117 is arranged between the boiler 118 and the superheater 116 along the at least one line 119. The at least one control valve 117 is configured to open, to close, and/or to regulate flow of the generated steam to the superheater 116. A portion of the steam received from the boiler 118 may also be directed to a steam release via a line 130. The superheater 116 directs superheated steam received from the boiler 118 that has been allowed to pass to the superheater 116 via the at least one control valve 117 to the ejector system 114 for reentry of the anode recirculation loop.

The boiler 118 is configured to direct at least a portion of the cooler slip stream 113 received from the superheater 116 to a condenser 120, which is located downstream of the boiler 118. The condenser 120 is configured to cause water in the cooler slip stream 113 to condense in a condenser sump pump 122. The condenser sump pump 122 is configured to pump liquid water to the boiler 118, thereby, providing a water supply internal to the system and advantageously alleviating a need for an external water supply.

The boiler 118 may include a first float control valve to direct water to the condenser sump pump 122 in response to an amount of water in the boiler 118 being greater than a predefined amount, e.g., as indicated by a float of the first valve. The boiler 118 may be operably coupled to a cathode exhaust and/or a water drain line. For example, a water drain line may be configured to spray or otherwise drain water in response to an excess of water in the condenser sump pump 122. Excess water in the condenser sump pump 122 may be indicated by a float of a second float valve being greater than a threshold amount.

In some instances, the condenser 120 condenses the water to a predefined dew point associated with the condenser 120. The condenser 120 may then direct dried cool gas into a cathode oxidizer 124. In one example, a cathode blower 126 may be configured to direct cooling air to the condenser 120 before entering a cathode heat exchanger 128.

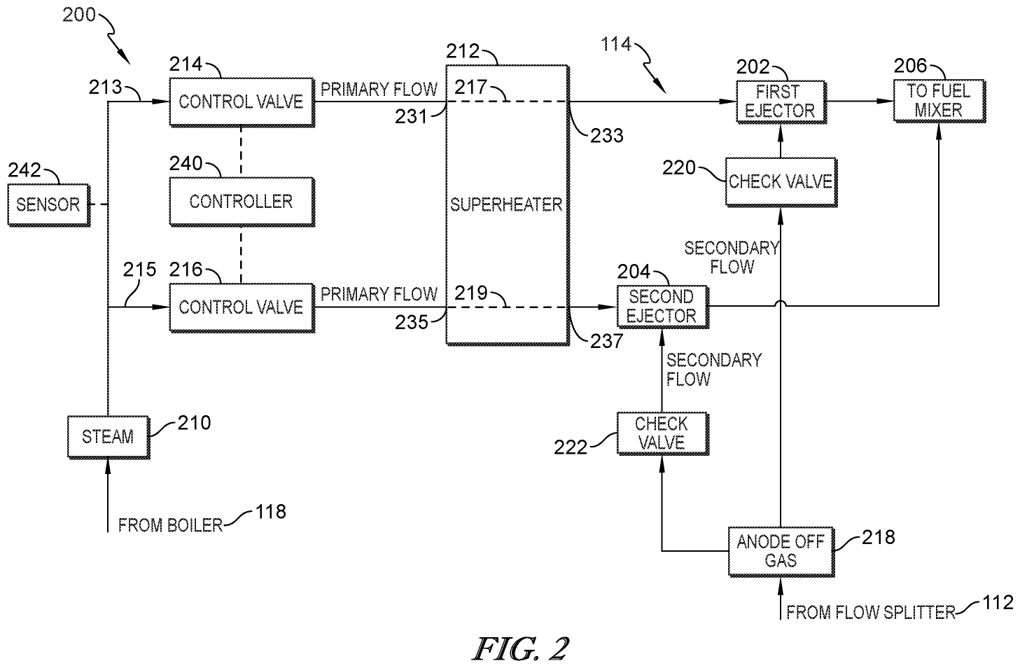

FIG. 2 illustrates an example ejector arrangement 200 for the anode off gas recirculation system 100 of the present disclosure. In an illustrative embodiment, the ejector system 114 of the arrangement 200 includes a first ejector 202 and a second ejector 204. The first ejector 202 and the second ejector 204 are each operably coupled to a fuel mixer 206. Each of the first and second ejectors 202, 204 may be at least partially or fully steam-driven.

In some instances, a first size of the first ejector 202 may be different from a second size of the second ejector 204. In an illustrative embodiment, the size of a given ejector comprises a combination of a first amount of steam input and a second amount of anode gas input to drive that ejector. In an exemplary embodiments, the second ejector 204 is larger than the first ejector 202.

In an illustrative embodiment, the second ejector 204 is twice the size of the first ejector 202. In other embodiments, the second ejector 204 is approximately twice the size of the first ejector 202, approximately being defined as +/−10% of twice the size, i.e. 1.9 and 2.1 times the size of the first ejector 202. The doubling or near doubling of the second ejector 204 relative to the first ejector 202 provides a range of operation by engaging or disengaging ejectors to selectively double flows, similar to binary counting as will be described in further detail below.

For example, with two ejectors, 4 operating conditions can be made with equal operating range between each condition. With three ejectors, such as in the arrangement 300 described below, 7 operating conditions can be made with equal operating range between each condition. With four ejectors, 16 operating conditions can be made with equal operating range between each condition.

For example, in one embodiment, 0 means off, 1 means on, and full operating load may be at 15 according to binary counting, such as is shown below. In another embodiment, binary counting may be further utilized to determine the combination range of operation for engaging or disengaging ejectors to selectively increase and/or double flows.

Off=0+0+0+0

1=1+0+0+0

2=0+2+0+0

3 =1+2+0+0

4=0+0+4+0

5=1+0+4+0

6=0+2+4+0

7=1+2+4+0

8=0+0+0+8

9=1+0+0+8

10=0+2+0+8

11=1+2+0+8

12=0+0+4+8

13=1+0+4+8

14=0+2+4+8

15=1+2+4+8

The doubling in size of the second ejector 204 over the first ejector 202 may be optimal in the context of the characteristics of exemplary ejectors used herein. It would be understood to one of ordinary skill in the art that alternative ejector designs may require larger or smaller increases in size to achieve the various operating conditions with equal operating range between each condition described above. In a further embodiment, the size of the second ejector 204 is greater than the size of the first ejector 202, but the increase in size of the second ejector 204 over the first ejector 202 is slightly more or less than double the size of the first ejector 202. For example, the size of the second ejector 204 over the first ejector 202 may be about 0.25 to about 3 times the size of the first ejector 202, including any specific or range of sizes comprised therein. In at least some embodiments, the minimum size of the first ejector and/or second ejector is at or about 100 microns.

Each of the first and second ejectors 202, 204 is further operably coupled to a superheater 212. The steam 210 from the boiler 118 as described above (see FIG. 1) is directed toward the superheater 212. A line from the boiler 118 splits into a first line 213 and a second line 215.

Also shown in FIG. 2, the first line 213 extends to a first control valve 214, and the second line 215 extends to a second control valve 216. Each of the first and second control valves 214, 216 is configured to open so as to allow steam passing through the first and second lines 213, 215, respectively, to flow to the superheater 212. The first and second control valves 214, 216 are also configured to close so as to prevent steam passing through the first and second lines 213, 215, respectively, to flow to the superheater 212. The first and second control valves 214, 216 can be operated independent of one another or together either opening/closing the same or a different amount.

The first and second lines 213, 215 extend downstream of the first and second control valves 214, 216 and continue to the superheater 212. In an illustrative embodiment, the first and second control valves 214, 216 are electrically and/or electronically controlled valves. In another embodiment, the first and second control valves 214, 216 are solenoid valves. Specifically, the first and second control valves 214, 216 may be electrically and/or electronically controlled solenoid valves. In some embodiments, the first and second control valves 214, 216 may be electrically and/or electronically controlled via a controller 240, which will be described in greater detail below.

The superheater 212 includes a first conduit 217 passing through the superheater 212. The first conduit 217 having a first input end 231 and a first output end 233. The first input end 231 is fluidically coupled to an output end of the first line 213.

Similarly, the superheater 212 further includes a second conduit 219 passing through the superheater 212, the second conduit 219 having a second input end 235 and a second output end 237. The second input end 235 is fluidically coupled to an output end of the second line 215. The superheater 212 is configured to increase the temperature of the steam as it flows through the first and second conduits 217, 219.

After having been superheated by the superheater 212, the steam flows to at least one of the first ejector 202 and the second ejector 204 through the first output end 233 and the second output end 237, respectively, so as to at least partially drive the respective ejector. The ejectors 202, 204 are driven by the high steam pressure being converted to high velocity steam at a lower pressure than the input. The high velocity causes the dynamic pressure of the steam to go below the static pressure of the secondary input, pulling the secondary gas into the ejector and joining the primary steam flow. The combined steam/gas flow gradually decreases velocity to reach a lower velocity & higher static pressure than the secondary gas input, driving the gas/steam mixture to recirculate. Put another way, the first and second control valves 214, 216 are configured to selectively direct the steam to and/or through one or both of the ejectors 202, 204. The proportion of steam going to the first and second ejectors 202, 204 is controlled by the control valves 214, 216.

In the illustrative embodiment, anode gas 109 is configured to flow to the first and second ejectors 202, 204 from the flow splitter 112 so as to partially drive the ejector(s). In some embodiments, anode gas 109 may not be fed to the ejector(s) 202, 204 such that the first and second ejectors 202, 204 are entirely steam-driven. Therefore, in some embodiments of the present system 100 or ejector system 114, the ejectors 202, 204 are not fuel-driven ejectors.

The ejector arrangement 200 of the present system 100 further includes a first check valve 220 arranged between the flow splitter 112 and the first ejector 202. The ejector arrangement 200 also comprises a second check valve 222 arranged between the flow splitter 112 and the second ejector 204. The first and second check valves 220, 222 are configured to prevent a portion of the anode off gas 109 that has flowed toward the first and second ejectors 202, 204, respectively, from flowing back toward the flow splitter 112.

The ejector arrangement 200 of the present system 100 operates to open the first and second control valves 214, 216. Specifically, the first and second control valves 214, 216 open and/or close in response to a value of one or more operating parameters of the system. Operating parameters of the present system 100 that may trigger the opening and/or closing of the first and second control valves 214, 216 include, but are not limited to, pressure, system power, system voltage, fuel flow rate, and steam flow rate. For example, when the operating parameters of the system 100 are greater than a first and/or a second threshold value, respectively, then the system may open the first or second control valves 214, 216, and thereby drive higher net steam flow.

These same outcomes may occur in response to a corresponding electronic signal from a remote signal and/or a control signal. Accordingly, the present ejector arrangement 200 is configured to selectively cause the control valves 214, 216 to open direct portions of the steam flow 210 to the superheater 212. The superheater 212, in turn, directs the steam flow 210 to the first and second ejectors 202, 204 such that the steam flow 210 is divided between the first ejector 202 and the second ejector 204.

Using a series of ejectors, e.g., the first and second ejectors 202, 204, having different sizes from one another may ensure that each ejector 202, 204 is operating near its own corresponding critical point, e.g., near Mach 1. Mach number M is indicative of a ratio of flow velocity past a boundary to the local speed of sound, as shown in Equation (1), such that:

$$M = \frac{u}{c} , \qquad ( 1 )$$

where M is indicative of the Mach number, U is indicative of a flow velocity with respect to boundaries (either internal, such as an object immersed in the flow, or external, e.g., a channel), and C is indicative of a speed of sound in a given medium. In particular, when the medium is air, the speed of sound c varies with the square root of the thermodynamic temperature. Accordingly, at Mach 1, the local flow velocity It is equal to the speed of sound in the fluid, e.g. steam.

In an illustrative embodiment (see FIG. 2), the first and second control valves 214, 216 are configured to open and close in response to the value of an operating parameter being equal to a specific threshold value so as to partially drive the first and second ejectors 202, 204. In particular, an illustrative system operating parameter is an average pressure of the generated steam 210.

Illustratively, in response to a value of the average pressure being equal to a first threshold value (i.e., about 7.8 bar), the first control valve 214 is opened. Opening the first control valve 214 allows the generated steam 210 to pass through the superheater 212 via the first conduit 217. The steam 210 then flows subsequently, downstream, to at least partially drive the first ejector 202. The first ejector 202 is coupled to the first output end 233 of the first conduit 217. In different system 100 embodiments, the first threshold value of about 7.8 bar may be altered based on the requirements of the system 100, as one of ordinary skill in the art would appreciate.

Subsequent to the opening of the first control valve 214, it is closed. Specifically, the first control valve 214 may be closed in response to the value of the operating parameter being equal to a second threshold value. In particular, the first control valve 214 is closed so as to prevent the generated steam 210 from passing through the first conduit 217 of the superheater 212.

Moreover, in response to the value of the operating parameter being equal to the second threshold value, the second control valve 216 is opened. Opening the second control valve 216 allows the generated steam 210 to pass through the superheater 212 via the second conduit 219. Subsequently downstream, opening the second control valve 216 may at least partially drive the second ejector 204 coupled to the second output end 237 of the second conduit 219. In the illustrative embodiment of FIG. 2, the second threshold value is also at or about 7.8 bar, although this threshold value may be altered based on the requirements of the system 100, as would be appreciated by person of ordinary skill in the art.

Subsequent to the closing of the first control valve 214 and opening of the second control valve 216, the value of the operating parameter becomes equal to a third threshold value. In response to the value of the operating parameter being equal to the third threshold value, the first control valve 214 is opened. Reopening the first control valve 214 allows the generated steam 210 to pass through the superheater 212.

The generated steam 210 flows through the superheater 212 via the first conduit 217. The generated steam 210 flows and subsequently, at least partially, drives the first ejector 202. The second control valve 216 is kept open so as to allow the generated steam 210 to also pass through the superheater 212. The generated steam 210 flows via the second conduit 219 and subsequently at least partially drives the second ejector 204.

In the illustrative embodiment, the third threshold value is also about 7.8 bar. Generally, the ejectors utilized herein prefer to operate with a primary flow that is near Mach 1. At least one exemplary embodiment of ejectors utilized herein achieve Mach 1 at approximately 7.8 bar. However, this threshold value may be altered based on the requirements of the system, as one of ordinary skill in the art would appreciate. For example, the first, second, and/or third threshold operating values for pressure may range from about 2 bar to 15 bar. In other embodiments, the first, second, and/or third threshold operating values for pressure may range from about 5 bar to 11 bar. Moreover, the term “about” or “approximately” 7.8 refers to any value within 10% of 7.8, i.e. 7 to 8.5. For other operating values, the predefined and/or threshold values may be any value and is determined by empirical data, lookup data, operator/user information, expertise, and/or knowledge.

The above-described order of driving the first and second ejectors 202, 204 allows for the total size of ejectors being utilized by the system 100 to increase stepwise when the valves 214, 216 are in the various configurations described in FIG. 2. One of ordinary skill in the art would understand that such an increase in size may be referred to as a binary counting method. In an exemplary scenario, a system 100 embodiment includes first and second ejectors 202, 204 in which the size of the first ejector 202 is equal to a unitless value of one (1) and the size of the second ejector 204 is equal to a unitless value of two (2). When only the first, smallest ejector 202 is being used, the total size of the ejectors being used is equal to 1. When only the second, next smallest ejector 204 is being used, the total size of the ejectors being used is equal to 2. Then, when both the first and second ejectors 202, 204 are being used, the total size of the ejectors being used is equal to 3.

In some embodiments, a controller 240 may be configured to control operation of the first and second control valves 214, 216 based on sensed operating parameter values. For example, a sensor assembly 242 may be arranged between the boiler 118 and the control valves 214, 216 so as to measure the average pressure of the steam. When the steam reaches the first threshold value, for example about 7.8 bar, the controller 240 may be configured to open the first control valve 214. The controller 240 is further configured to execute the operation of the control valves 214, 216 described above when the average pressure reaches at or about 7.8 bar.

The controller 240 may include, be configured to be connected, or be connected to at least one processor. The processor may be connected to a computer readable memory and/or any other data storage. Computer executable instructions and/or data used by the processor and that may be stored in the computer readable memory include, but is not limited to, an onboard computing device, a remote server, a combination of both, or implemented with any combination of read only memory modules or random access memory modules. Computer memory modules optionally include both volatile and nonvolatile memory.

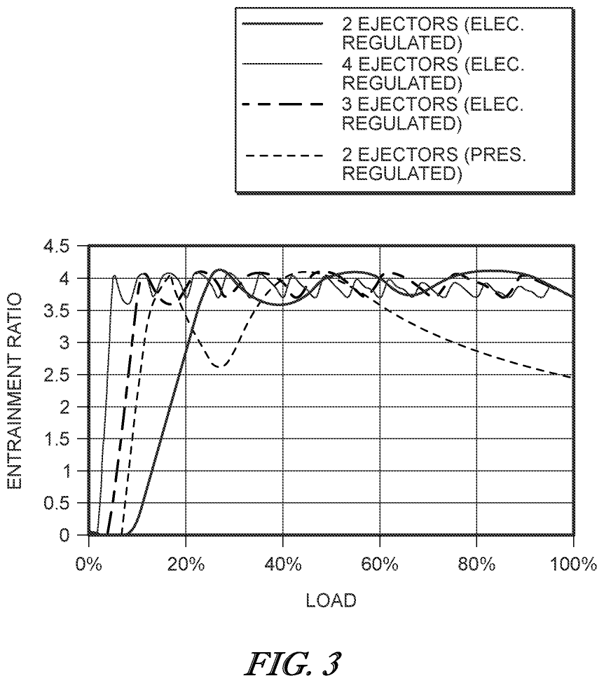

FIG. 3 shows a graph that plots the load of the system 100 versus the entrainment ratio of the system for exemplary ejector arrangements (e.g., two (2) ejectors that are only pressure regulated, two (2) ejectors that are electrically regulated according to the disclosed embodiments such as arrangement 200, triple (3) ejectors that are electrically regulated according to the disclosed embodiments such as arrangement 300, and quadruple (4) ejectors that are electrically regulated according to the disclosed embodiments). The entrainment ratio of the system 100 is defined as the secondary mass flow of the system, i.e. the anode off gas 109, divided by the primary mass flow, i.e. the steam flow. Ideally, it is desired that the system reach a minimum operating condition as fast as possible at the lowest load possible, and subsequently remain above a minimum entrainment ratio. The “load” in the graph refers to the amount of fuel consumed relative to the maximum amount of fuel consumption that the for which the system is designed.

An entrainment ratio at various loads for a pressure regulated single ejector system is shown in FIG. 3. For additional description of such a single ejector system, see PCT/US2021/060467 entitled “STEAM-DRIVEN SOLID OXIDE FUEL CELL ANODE OFF GAS RECIRCULATION EJECTOR SYSTEM WITH WATER RECOVER” filed Nov. 23, 2021. Please also refer to U.S. Provisional Patent Application Ser. No. 63/118,355 entitled “STEAM-DRIVEN SOLID OXIDE FUEL CELL ANODE OFF GAS RECIRCULATION EJECTOR SYSTEM WITH WATER RECOVERY” filed Nov. 25, 2020, the contents of both of which are incorporated herein by reference.

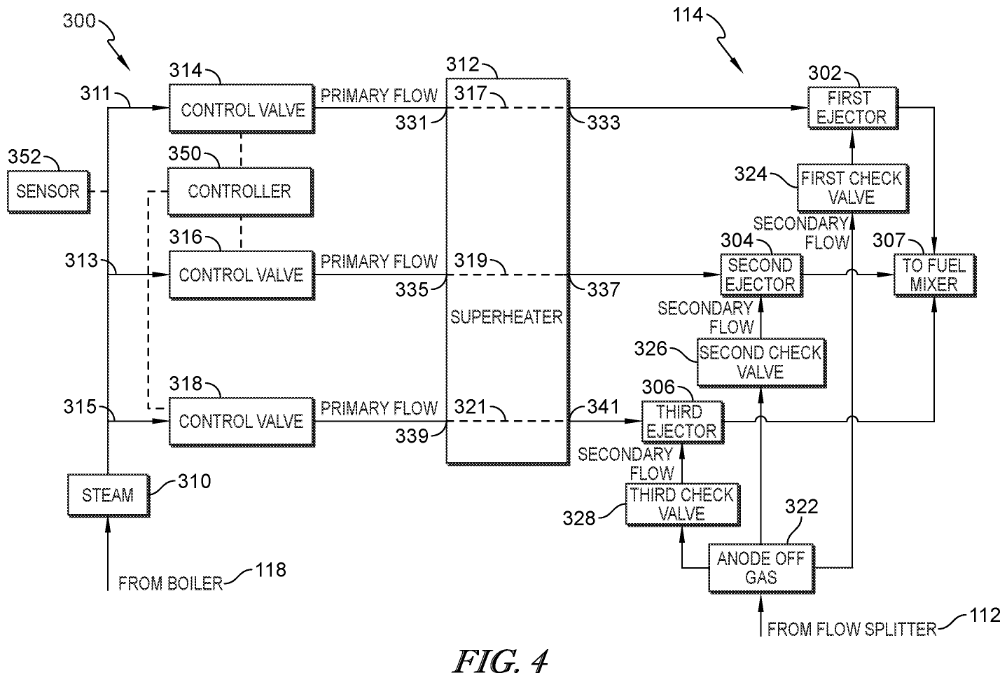

As a further example, the load demand for the dual ejector arrangement 200 is shown in FIG. 3. As can be seen, the entrainment ratio for the dual ejector system 100 reaches an optimized entrainment ratio of 3.5, and remains above 3.5 in response to the first ejector 202 and the second ejector 206 operating at or above a 22% load. In other exemplary embodiments, such as a three-ejector arrangement 300 (see FIG. 4), an optimized entrainment ratio of 3.5 is reached and remains above 3.5 in response to three ejectors 302, 304, 306 operating at or above a 9% load. In an ejector arrangement of the present system 100, 200, 300 in which four ejectors are utilized, an optimized entrainment ratio of 3.5 is reached and remains at or above 3.5 in response to four ejectors operating at or above a 4% load.

A three-ejector arrangement 300 in accordance with the present disclosure is shown in FIG. 4. The arrangement 300 is substantially similar to the arrangement 200 shown in FIG. 2 and described herein except it comprises an additional ejector in a multi-ejector system. Accordingly, similar reference numbers in the 300 series indicate features that are common between the ejector arrangement 300 and the ejector arrangement 200 embodiments. The description of the arrangement 200 is incorporated by reference to apply to the arrangement 300, except in instances when it conflicts with the specific description and the drawings of the arrangement 300.

As shown in FIG. 4, the ejector system 114 of the exemplary arrangement 300 includes a first ejector 302, a second ejector 304, and a third ejector 306 each operably coupled to a fuel mixer 307. Each of the first, second, and third ejectors 302, 304, 306 may be at least partially or fully steam-driven. In some instances, the ejectors 302, 304, 306 may vary in sizes.

In the illustrative embodiment, the third ejector 306 is twice the size of the second ejector 304, and the second ejector 304 is twice the size of the first ejector 302. In other embodiments, the third ejector 306 is larger than the second ejector 304, and the second ejector 304 is larger than the first ejector 302, but the increase in size between the subsequent ejectors is slightly more or less than double the size of the previous ejector. For example, the size of the third ejector 306 over the first ejector 302 and/or the second ejector 304 may be about 3 to about 10 times the size of the first ejector 202, including any specific or range of sizes comprised therein. The size of the third ejector 306 over the first ejector 302 and/or the second ejector 304 may also be about 0.25 to about 1.99 times the size of the first ejector 202, including any specific or range of sizes comprised therein. In at least some embodiments, the minimum size of the ejectors is at or about 100 microns.

Each of the ejectors 302, 304, 306 are further operably coupled to a superheater 312. The steam 310 from the boiler 118 as described above is directed toward the superheater 312. A line from the boiler 118 splits into a first line 311, a second line 313, and a third line 315.

The first line 311 extends to a first control valve 314. The second line 313 extends to a second control valve 316. The third line 315 extends to a third control valve 318. Each of the control valves 314, 316, 318 is configured to open so as to allow steam passing through the first, second, and third lines 311, 313, 315, respectively, to flow to the superheater 312. Each of the control valves 314, 316, 318 is also configured to close so as to prevent steam from passing through the first, second, and third lines 311, 313, 315, respectively, to flow to the superheater 312.

The first line 311 continues and extends downstream of the first valve 314 to the superheater 312. The second line 313 continues and extends downstream of the second valve 316 to the superheater 312. The third line 315 continues and extends downstream of the third valve 318 to the superheater 312. In the illustrative embodiment, the first, second, and third control valves 314, 316, 318 are electrically controlled valves. Specifically, the first, second, and third control valves 314, 316, 318 may be electrically controlled solenoid valves. In some embodiments, the first, second, and third control valves 314, 316, 318 may be electrically and/or electronically controlled via a controller 350, which will be described in greater detail below.

The superheater 312 includes a first conduit 317 passing through the superheater 312, the first conduit 317 having a first input end 331 and a first output end 333. The first input end 331 is fluidically coupled to an output end of the first line 311. Similarly, the superheater 312 further includes a second conduit 319 passing through the superheater 312, the second conduit 319 having a second input end 335 and a second output end 337. The second input end 335 is fluidically coupled to an output end of the second line 313. The superheater 312 further includes a third conduit 321 passing through the superheater 312, the third conduit 321 having a third input end 339 and a third output end 341. The third input end 341 is fluidically coupled to an output end of the third line 315. The superheater 312 is configured to increase the temperature of the steam as it flows through the first, second, and third conduits 317, 319, 321.

After having been superheated by the superheater 312, the steam flows to at least one of the plurality of ejectors, in particular the first ejector 302, the second ejector 304, and/or the third ejector 306, so as to at least partially drive the ejector(s). Put another way, the control valves 314, 316, 318 are configured to selectively direct the steam to one, two, or all of the ejectors 302, 304, 306. The proportion of steam going to the ejectors 302, 304, 306 is controlled by the control valves 314, 316, 318.

In the illustrative embodiment, anode gas is configured to flow to the ejectors 302, 304, 306 from the flow splitter 112 so as to partially drive the ejector(s). In some embodiments, anode gas may not be fed to the ejector(s) such that the ejectors 302, 304, 306 are entirely steam-driven.

The arrangement 300 of the present system 100 further includes a first check valve 324 arranged between the flow splitter 112 and the first ejector 302. The arrangement 300 further includes a second check valve 326 arranged between the flow splitter 112 and the second ejector 304. The arrangement 300 further includes a third check valve 328 arranged between the flow splitter 112 and the third ejector 306. The first, second, and third check valves 324, 326, 328 are configured to prevent a portion of the anode off gas that has flowed toward the first, second, and third ejectors 302, 304, 306, respectively, from flowing back toward the flow splitter 112.

The arrangement 300 of the present system 100 operates similarly to the arrangement 200, in particular to open the control valves 314, 316, 318. In particular, the first, second, and third control valves 314, 316, 318 open and/or close in response to a value of one or more operating parameters of the system. Operating parameters of the present system 100 that may trigger the opening and/or closing of the first, second, and third control valves 314, 316, 318 include, but are not limited to, pressure, system power, system voltage, fuel flow rate, and steam flow rate. For example, when the operating parameters of the system 100 are greater than a first and/or a second threshold value, respectively, then the system 100 may open the first, second, and/or third control valves 314, 316, 318, thereby driving higher net steam flows.

These same outcomes may occur in response to corresponding electronic signals from a remote signal and/or a control signal. Accordingly, the present ejector arrangement 300 is configured to selectively cause the control valves 314, 316, 318 to open to direct portions of the steam flow 310 to the superheater 312 that, in turn, directs it to the first, second, and third ejectors 302, 304, 306 such that the steam flow 310 is divided between the ejectors 302, 304, 306.

In an illustrative embodiment (see FIG. 4), the control valves 314, 316, 318 are configured to open and close in response to the value of an operating parameter being equal to a specific threshold value so as to partially drive the ejectors 302, 304, 306. In particular, an illustrative system operating parameter is an average pressure of the generated steam 310.

Illustratively, in response to a value of the average pressure being equal to a first threshold value (i.e. about 7.8 bar), the first control valve 314 is opened. Opening the first control valve 314 allows the generated steam 310 to pass through the superheater 312 via the first conduit 317. The steam 310 then flows subsequently, downstream, to at least partially drive the first ejector 302 that is coupled to the first output end 333 of the first conduit 317. In different system embodiments, the first threshold value of 7.8 bar may be altered based on the requirements of the system 100, as one of ordinary skill in the art would appreciate.

Subsequent to the opening of the first control valve 314, the control valve 314 is closed. Specifically, the first control valve 314 is closed in response to the value of the operating parameter being equal to a second threshold value. The first control valve 314 is closed so as to prevent the generated steam 310 from passing through the first conduit 317 of the superheater 312.

Moreover, in response to the value of the operating parameter being equal to the second threshold value, the second control valve 316 is opened. Opening the second control valve 316 allows the generated steam 310 to pass through the superheater 312 via the second conduit 319. Subsequently, downstream, opening the second control valve 316 may at least partially drive the second ejector 304 coupled to the second output end 337 of the second conduit 319. In the illustrative embodiment of FIG. 4, the second threshold value may also be at or about 7.8 bar, although this threshold value may be altered based on the requirements of the system 100, as would be appreciated by one of ordinary skill in the art.

Subsequent to the closing of the first control valve 314 and opening of the second control valve 316, the value of the operating parameter becomes equal to a third threshold value. In response to the value of the operating parameter being equal to the third threshold value, the first control valve 314 is reopened. Reopening the first control valve 314 allows the generated steam 310 to pass through the superheater 312 via the first conduit 317 and subsequently at least partially drive the first ejector 302.

Moreover, in response to the operating parameter being equal to the third threshold valve, the second control valve 316 is kept open. Keeping open the second control valve 316 allows the generated steam 310 to continue to pass through the superheater 312 via the second conduit 319 and subsequently at least partially drive the second ejector 304. In the illustrative embodiment of FIG. 4, the third threshold value may also be at or about 7.8 bar, although this threshold value may be altered based on the requirements of the system 100, as would be appreciated by one of ordinary skill in the art.

Subsequent to the opening of both the first control valve 314 and the second control valve 316, the value of the operating parameter becomes equal to a fourth threshold value. In response to the value of the operating parameter being equal to the fourth threshold value, the first and second control valves 314, 316 are closed. Closing the first and second control valves 314, 316 prevents the generated steam 310 from passing through the first and second conduits 317, 319 of the superheater 312.

Moreover, in response to the value of the operating parameter being equal to the fourth threshold value, the third control valve 318 is opened. Opening the third control valve 318 allows the generated steam 310 to pass through the superheater 312 via the third conduit 321 and subsequently at least partially drive the third ejector 306. In the illustrative embodiment of FIG. 4, the fourth threshold value may also be at or about 7.8 bar, although this threshold value may be altered based on the requirements of the system 100, as would be appreciated by one of ordinary skill in the art.

Subsequent to the closing of the first and second control valves 314, 316 and the opening of the third control valve 318, the value of the operating parameter becomes equal to a fifth threshold value. In response to the value of the operating parameter being equal to the fifth threshold value, the second control valve 316 is closed. Closing the second control valve 316 prevents the generated steam 310 from passing through the second conduit 319 of the superheater 312.

Moreover, in response to the value of the operating parameter being equal to the fifth threshold value, the first and third control valves 314, 318 are opened. Opening the first and third control valves 314, 318 allows the generated steam 310 to pass through the superheater 312 via the first and third conduits 317, 321. Subsequently, the steam 310 may at least partially drive the first and third ejectors 302, 306. In the illustrative embodiment of FIG. 4, the fifth threshold value may also be at or about 7.8 bar, although this threshold value may be altered based on the requirements of the system 100, as would be appreciated by one of ordinary skill in the art.

Subsequent to the opening of both the first control valve 314 and the third control valve 318 and closing of the second control valve 316, the value of the operating parameter becomes equal to a sixth threshold value. In response to the value of the operating parameter being equal to the sixth threshold value, the first control valve 314 is closed. Closing the first control valve 314 prevents the generated steam 310 from passing through the first conduit 317 of the superheater 312.

Moreover, in response to the value of the operating parameter being equal to the sixth threshold value, the second and third control valves 316, 318 are opened. Opening the second and third control valves 316, 318 allows the generated steam 310 to pass through the superheater 312 via the second and third conduits 319, 321. Subsequently, the steam 310 may at least partially drive the second and third ejectors 304, 306. In the illustrative embodiment of FIG. 4, the sixth threshold value may also be at or about 7.8 bar, although this threshold value may be altered based on the requirements of the system 100, as would be appreciated by one of ordinary skill in the art.

Finally, subsequent to the opening of both the second control valve 316 and the third control valve 318, the value of the operating parameter becomes equal to a seventh threshold value. In response to the value of the operating parameter being equal to the seventh threshold value, the first, second, and third control valves 314, 316, 318 are opened. Opening the first, second, and third control valves 314, 316, 318 allows the generated steam 310 to pass through the superheater 312 via the first, second, and third conduits 317, 319, 321. Subsequently, the steam 310 may at least partially drive the first, second, and third ejectors 302, 304, 306. In the illustrative embodiment of FIG. 4, the seventh threshold value may also be at or about 7.8 bar, although this threshold value may be altered based on the requirements of the system 100, as would be appreciated by one of ordinary skill in the art.

Similar to the arrangement 200, the above-described order of driving the first, second, and third ejectors 302, 304, 306 allows for the total size of ejector being utilized by the system to increase stepwise when the valves 314, 316, 318 are in the various configurations described above. For example, in an embodiment where the size of the first ejector 302 is one (1), the size of the second ejector 304 is two (2), and the size of the third ejector 306 is four (4), when only the first, smallest ejector 302 is being used, the total size of the ejectors being used is equal to 1. When only the second, next smallest ejector 304 is being used, the total size of the ejectors being used is equal to 2. Then, when both the first and second ejectors 302, 304 are being used, the total size of the ejectors being used is equal to 3. Then, when only the third, largest ejector 306 is being used, the total size of the ejectors being used is equal to 4. Then, when both the first and third ejectors 302, 306 are being used, the total size of the ejectors being used is equal to 5. Then, when both the second and third ejectors 304, 306 are being used, the total size of the ejectors being used is equal to 6. Finally, when all three ejectors 302, 304, 306 are being used, the total size of the ejectors being used is equal to 7.

In some embodiments, a controller 350 may be configured to control operation of the control valves 314, 316, 318 based on sensed operating parameter values. For example, a sensor assembly 342 may be arranged between the boiler 118 and the control valves 314, 316, 318 so as to measure the average pressure of the steam. When the steam reaches the first threshold value, for example 7.8 bar, the controller 350 may be configured to open the first control valve 314. The controller 350 is further configured to execute the operation of the control valves 314, 316, 318 described above when the average pressure reaches 7.8 bar.

In further non-limiting embodiments of the system 100 and method 400, including the arrangements 200, 300, of the present disclosure, the plurality of ejectors may include additional ejectors, such as four, five, or more ejectors. In some embodiments, the system may include 6 ejectors, 7 ejectors, 8 ejectors, 9 ejectors, 10 ejectors, 11 or more ejectors, or 20 or more ejectors. The ejectors of such embodiments are arranged and configured to operate similarly to the two ejector and three ejector embodiments described above. Specifically, these multi-ejector embodiments open and close based on threshold values. Specifically, the valves are configured to open and close for an arrangement including four ejectors (i.e. n+3 ejectors) according to the order shown in Table 1, where each subsequent ejector (i.e. ejector n, n+1, n+2, n+3) is twice the size of the previous ejector, although the increase in size of subsequent ejectors may be different than double the size in other embodiments. This same pattern of opening and closing valves would apply to any arrangement for n+i ejectors. Similar to the embodiments, described above, the various threshold values may all be equal to each other, in particular 7.8 bar. In other embodiments, the threshold values may vary. Each step or combination of opening and closing the ejectors shown in Table 1 will increase the overall operating size of the ejector combination by 1 when assuming each ejector is doubled up in size relative to the previous ejector (i.e. “ejector n”=1 size unit, “ejector n+1”=2 size units, “ejector n+2”=4 size units, “ejector n+3”=8 size units). In other words, the total size of ejectors utilized will be equal to 1, 2, 3, 4, 5, 6, 7, 8, 9, 10, 11, 12, 13, 14, and 15 for the 1^{st}, 2^{nd}, 3^{rd}, 4^{th}, 5^{th}, 6^{th}, 7^{th}, 8^{th}, 9^{th}, 10^{th}, 11^{th}, 12^{th}, 13^{th}, 14^{th}, and 15^{th} threshold value scenarios, respectively, shown in Table 1.

TABLE 1

| | | Ejector | Ejector | |
|---|---|---|---|---|
| Threshold Value | Ejector n | n + 1 | n + 2 | Ejector n + 3 |
| 1st threshold value | OPENED | CLOSED | CLOSED | CLOSED |
| 2nd threshold value | CLOSED | OPENED | CLOSED | CLOSED |
| 3rd threshold value | OPENED | OPENED | CLOSED | CLOSED |
| 4th threshold value | CLOSED | CLOSED | OPENED | CLOSED |
| 5th threshold value | OPENED | CLOSED | OPENED | CLOSED |
| 6th threshold value | CLOSED | OPENED | OPENED | CLOSED |
| 7th threshold value | OPENED | OPENED | OPENED | CLOSED |
| 8th threshold value | CLOSED | CLOSED | CLOSED | OPENED |
| 9th threshold value | OPENED | CLOSED | CLOSED | OPENED |
| 10th threshold value | CLOSED | OPENED | CLOSED | OPENED |
| 11th threshold value | OPENED | OPENED | CLOSED | OPENED |
| 12th threshold value | CLOSED | CLOSED | OPENED | OPENED |
| 13th threshold value | OPENED | CLOSED | OPENED | OPENED |
| 14th threshold value | CLOSED | OPENED | OPENED | OPENED |
| 15th threshold value | OPENED | OPENED | OPENED | OPENED |

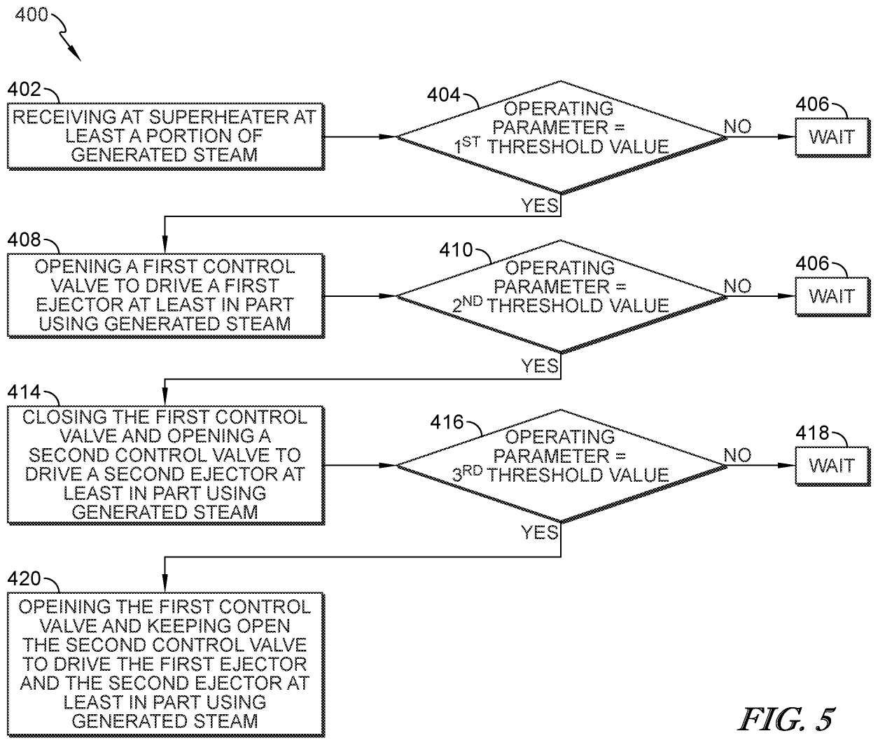

FIG. 5 illustrates an example process 400 of the present disclosure for recirculating an anode off gas in accordance with the present disclosure. The process 400 begins at block 402, which includes receiving, at a flow splitter, the anode off gas generated by an anode of a fuel cell, directing, at the flow splitter, a first portion of the received anode off gas to a superheater, cooling, at the superheater, the portion of the anode off gas received from the flow splitter and directing at least a portion of the cooled portion of the anode off gas to a boiler, and generating, at the boiler, steam and directing at least a portion of the generated steam to the superheater. At block 404, the recirculation system determines whether a value of one or more operating parameters of the system, such as, but not limited to, pressure, system power, system voltage, fuel flow rate, and steam flow rate, is equal to a predefined first threshold value. If the value is not equal to the first threshold value, the system waits a predefined period at block 406.

In response to detecting at block 404 that the value is equal to the first threshold value, the process 400 moves to block 408, when a first control valve arranged between the boiler and the superheater is opened so as to allow the generated steam to pass through the superheater via a first conduit within the superheater and subsequently at least partially drive a first ejector coupled to an output end of the first conduit. At block 410, the recirculation system determines whether the value of the operating parameter(s) of the system are equal to a predefined second threshold value. If the value is not equal to the second threshold value, the system waits a predefined period at block 412.

In response to detecting at block 410 that the value is equal to the second threshold value, the process 400 moves to block 414, when the first control valve is closed to prevent the generated steam from passing through the first conduit within the superheater and subsequently at least partially driving the first ejector, and when a second control valve arranged between the boiler and the superheater is opened to allow the generated steam to pass through the superheater via a second conduit within the superheater and subsequently at least partially drive a second ejector coupled to the output end of the second conduit. At block 416, the recirculation system determines whether the value of the operating parameter(s) of the system are equal to a predefined third threshold value. If the value is not equal to the third threshold value, the system waits a predefined period at block 418.

In response to detecting at block 416 that the value is equal to the third threshold value, the process 400 moves to block 420, when the first control valve is opened so as to allow the generated steam to pass through the first conduit within the superheater and subsequently at least partially drive the first ejector, and when the second control valve arranged between the boiler and the superheater is kept open so as to allow the generated steam to pass through the superheater via the second conduit within the superheater and subsequently at least partially drive the second ejector.

In accordance with the present disclosure, a superheater is used to remove some of the heat from (lower a temperature of) the slip gas before the slip gas enters the boiler. This implementation increases the effectiveness of the steam in the ejector while also removes heat from the slip stream. Removing heat from the slip stream prevents the heat from overwhelming the boiler and causing excessive boiling, such that an amount of water recovered becomes insufficient to continue effective anode off gas recirculation. Moreover, running at least two ejectors in a configuration consistent with the present disclosure enables operating each ejector near its associated optimum condition, near Mach 1, to maximize the ratio of the anode off gas recirculation mass moved to steam mass consumed over a wider range of conditions.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

The following numbered embodiments are contemplated and are non-limiting.
1. A method for recirculating an anode off gas in a fuel cell assembly includes receiving, at a flow splitter, the anode off gas generated by an anode of a fuel cell, directing, at the flow splitter, a first portion of the received anode off gas to a superheater, cooling, at the superheater, the portion of the anode off gas received from the flow splitter and directing at least a portion of the cooled portion of the anode off gas to a boiler.
2. The method of clause 1, any other suitable clause, or any combination of suitable clauses, further including generating, at the boiler, steam and directing at least a portion of the generated steam to the superheater.
3. The method of clause 2, any other suitable clause, or any combination of suitable clauses, further including directing a first portion of the generated steam to a first control valve of a plurality of control valves arranged between the boiler and the superheater and directing a second portion of the generated steam to a second control valve of the plurality of control valves arranged between the boiler and the superheater, the first control valve being in fluid communication with a first conduit that passes through the superheater and fluidically connects to a first ejector of a plurality of ejectors coupled to a first output end of the first conduit, the second control valve being in fluid communication with a second conduit that passes through the superheater and fluidically connects to a second ejector of the plurality of ejectors coupled to a second output end of the second conduit.
4. The method of clause 3, any other suitable clause, or any combination of suitable clauses, further including, in response to a value of an operating parameter being equal to a first threshold value, opening the first control valve to allow the generated steam to pass through the superheater via the first conduit and subsequently at least partially drive the first ejector.

5. The method of clause 4, any other suitable clause, or any combination of suitable clauses, further including, in response to the value of the operating parameter being equal to a second threshold value, closing the first control valve to prevent the generated steam from passing through the first conduit within the superheater and subsequently at least partially driving the first ejector, and opening the second control valve to allow the generated steam to pass through the superheater via the second conduit within the superheater and subsequently at least partially drive the second ejector.

6. The method of clause 5, any other suitable clause, or any combination of suitable clauses, wherein the first ejector has a first size and the second ejector has a second size.

7. The method of clause 6, any other suitable clause, or any combination of suitable clauses, wherein the first and second sizes are defined as a maximum capacity of a first amount of generated steam and second amount of anode off gas of the first and second ejectors.

8. The method of clause 7, any other suitable clause, or any combination of suitable clauses, wherein the second size is at least twice the first size.

9. The method of clause 8, any other suitable clause, or any combination of suitable clauses, wherein the second threshold value is equal to the first threshold value.

10. The method of clause 9, any other suitable clause, or any combination of suitable clauses, wherein the operating parameter is an average pressure of the generated steam.

11. The method of clause 10, any other suitable clause, or any combination of suitable clauses, wherein the first threshold value and the second threshold value are approximately 7.8 bar.

12. The method of clause 5, any other suitable clause, or any combination of suitable clauses, wherein the first control valve and the second control valve are electrically controlled.

13. The method of clause 5, any other suitable clause, or any combination of suitable clauses, wherein the first control valve and the second control valve are solenoid valves.

14. The method of clause 5, any other suitable clause, or any combination of suitable clauses, further including directing, at the flow splitter, a second portion of the received anode off gas to the first ejector.

15. The method of clause 14, any other suitable clause, or any combination of suitable clauses, further including preventing the second portion of the received anode off gas from flowing back toward the flow splitter via a first check valve arranged between the first ejector and the flow splitter.

16. The method of clause 15, any other suitable clause, or any combination of suitable clauses, further including directing, at the flow splitter, a third portion of the received anode off gas to the second ejector.

17. The method of clause 16, any other suitable clause, or any combination of suitable clauses, preventing the third portion of the received anode off gas from flowing back toward the flow splitter via a second check valve arranged between the second ejector and the flow splitter.

18. The method of clause 5, any other suitable clause, or any combination of suitable clauses, wherein the generated steam enters the superheater via a first input end of the first conduit of the superheater, increases in temperature within the superheater, exits via a first output end of the first conduit, and subsequently drives the first ejector.

19. The method of clause 5, any other suitable clause, or any combination of suitable clauses, wherein the generated steam further enters the superheater via a second input end of the second conduit of the superheater, increases in temperature within the superheater, exits via a second output end of the second conduit, and subsequently drives the second ejector.

20. The method of clause 5, any other suitable clause, or any combination of suitable clauses, wherein an entrainment ratio remains above 3.5 in response to the first ejector and the second ejector operating at or above a 22% load.

21. The method of clause 5, any other suitable clause, or any combination of suitable clauses, further including, in response to the value of the operating parameter being equal to a third threshold value, opening the first control valve to allow the generated steam to pass through the superheater via the first conduit within the superheater and subsequently at least partially drive the first ejector, and keeping open the second control valve to allow the generated steam to also pass through the superheater via the second conduit within the superheater and subsequently at least partially drive the second ejector.

22. The method of clause 21, any other suitable clause, or any combination of suitable clauses, wherein the third threshold value is equal to the second threshold value and the first threshold value.

23. The method of clause 22, any other suitable clause, or any combination of suitable clauses, further including, in response to the value of the operating parameter being equal to a fourth threshold value, the first and second control valves are closed so as to prevent the generated steam from passing through the first and second conduits of the superheater.

24. The method of clause 23, any other suitable clause, or any combination of suitable clauses, further including, in response to the value of the operating parameter being equal to the fourth threshold value, the third control valve is opened so as to allow the generated steam to pass through the superheater via the third conduit and subsequently at least partially drive the third ejector.

25. The method of clause 24, any other suitable clause, or any combination of suitable clauses, wherein the fourth threshold value is equal to the first, second, and third threshold values.

26. The method of clause 25, any other suitable clause, or any combination of suitable clauses, further including, in response to the value of the operating parameter being equal to a fifth threshold value, the second control valve is closed so as to prevent the generated steam from passing through the second conduit of the superheater.

27. The method of clause 26, any other suitable clause, or any combination of suitable clauses, further including, in response to the value of the operating parameter being equal to the fifth threshold value, the first and third control valves are opened so as to allow the generated steam to pass through the superheater via the first and third conduits and subsequently at least partially drive the first and third ejectors.

28. The method of clause 27, any other suitable clause, or any combination of suitable clauses, wherein the fifth threshold value is equal to the first, second, third, and fourth threshold values.

29. The method of clause 28, any other suitable clause, or any combination of suitable clauses, further including, in response to the value of the operating parameter being equal to a sixth threshold value, the first control valve is closed so as to prevent the generated steam from passing through the first conduit of the superheater.

30. The method of clause 29, any other suitable clause, or any combination of suitable clauses, further including, in response to the value of the operating parameter being equal to the sixth threshold value, the second and third control valves are opened so as to allow the generated steam to pass through the superheater via the second and third conduits and subsequently at least partially drive the second and third ejectors.

31. The method of clause 30, any other suitable clause, or any combination of suitable clauses, wherein the sixth threshold value is equal to the first, second, third, fourth, and fifth threshold values.

32. The method of clause 31, any other suitable clause, or any combination of suitable clauses, further including, in response to the value of the operating parameter being equal to a seventh threshold value, the first, second, and third control valves are opened so as to allow the generated steam to pass through the superheater via the first, second, and third conduits and subsequently at least partially drive the first, second, and third ejectors.

33. The method of clause 32, any other suitable clause, or any combination of suitable clauses, wherein the seventh threshold value is equal to the first, second, third, fourth, fifth, and sixth threshold values.

34. The method of clause 21, any other suitable clause, or any combination of suitable clauses, wherein a controller is be configured to control operation of the first and second control valves based on the first, second, and third threshold values.

35. The method of clause 34, any other suitable clause, or any combination of suitable clauses, wherein at least one sensor is configured to measure the average pressure of the steam and determine if the average pressure is equal to the first, second, and third threshold values.

36. The method of clause 33, any other suitable clause, or any combination of suitable clauses, wherein a controller is be configured to control operation of the first and second control valves based on the first, second, third, fourth, fifth, sixth, and seventh threshold values.

37. The method of clause 36, any other suitable clause, or any combination of suitable clauses, wherein at least one sensor is configured to measure the average pressure of the steam and determine if the average pressure is equal to the first, second, third, fourth, fifth, sixth, and seventh threshold values.

38. The method of clause 34, any other suitable clause, or any combination of suitable clauses, wherein the entrainment ratio reaches an optimized entrainment ratio of 3.5, and remains above 3.5 in response to the three ejectors operating at or above a 9% load.

39. A method for recirculating an anode off gas in a fuel cell assembly includes generating steam from the anode off gas and directing at least a portion of the generated steam to a superheater.

40. The method of clause 39, any other suitable clause, or any combination of suitable clauses, further including, in response to a value of an operating parameter being equal to a first threshold value, opening a first control valve arranged upstream of the superheater to allow the generated steam to pass through the superheater via a first conduit within the superheater and subsequently at least partially drive a first ejector coupled to an output end of the first conduit.

41. The method of clause 40, any other suitable clause, or any combination of suitable clauses, further including, in response to the value of the operating parameter being equal to a second threshold value, closing the first control valve to prevent the generated steam from passing through the first conduit within the superheater and subsequently at least partially driving the first ejector, and opening a second control valve arranged upstream of the superheater to allow the generated steam to pass through the superheater via a second conduit within the superheater and subsequently at least partially drive a second ejector coupled to the output end of the second conduit.

42. The method of clause 41, any other suitable clause, or any combination of suitable clauses, wherein the first ejector has a first main diameter and the second ejector has a second main diameter, and wherein the second main diameter is twice the first main diameter.

43. The method of clause 40, any other suitable clause, or any combination of suitable clauses, further including, in response to the value of the operating parameter being equal to a third threshold value, opening the first control valve to allow the generated steam to pass through the superheater via the first conduit within the superheater and subsequently at least partially drive the first ejector, and keeping open the second control valve to allow the generated steam to also pass through the superheater via the second conduit within the superheater and subsequently at least partially drive the second ejector.

44. A recirculation system for a fuel cell assembly includes a flow splitter, a superheater, a boiler, a plurality of ejectors, and a plurality of control valves.

45. The recirculation system of clause 44, any other suitable clause, or any combination of suitable clauses, wherein the flow splitter is operably coupled to an anode of the fuel cell and configured to receive an anode off gas therefrom.

46. The recirculation system of clause 45, any other suitable clause, or any combination of suitable clauses, wherein the superheater is disposed downstream from the flow splitter and configured to cool a portion of the anode off gas received through the flow splitter, the superheater including a first conduit and a second conduit, the first conduit arranged within the superheater so as to pass through the superheater, the first conduit including a first output end, the second conduit arranged within the superheater so as to pass through the superheater, the second conduit including a second output end.

47. The recirculation system of clause 46, any other suitable clause, or any combination of suitable clauses, wherein the boiler is operably coupled to the superheater and configured to receive the portion of the anode off gas cooled by the superheater, the boiler further configured to generate steam and direct at least a portion of the generated steam to the superheater.

48. The recirculation system of clause 47, any other suitable clause, or any combination of suitable clauses, wherein the plurality of ejectors includes a first ejector and a second ejector, the first ejector arranged downstream of the superheater and coupled to the first output end of the first conduit, the first ejector configured to be driven at least partially by the generated steam from the superheater, the second ejector arranged downstream of the superheater and coupled to the second output end of the second conduit, the second ejector configured to be driven at least partially by the generated steam from the superheater.

49. The recirculation system of clause 48, any other suitable clause, or any combination of suitable clauses, wherein the plurality of control valves includes a first control valve and a second control valve, the first control valve arranged between the boiler and the superheater, the first control valve configured to open so as to allow the generated steam to pass through the superheater via the first conduit within the superheater and configured to close so as to prevent the generated steam from passing through the superheater via the first conduit within the superheater, the second control valve configured to open so as to allow the generated steam to pass through the superheater via the second conduit within the superheater and configured to close so as to prevent the generated steam from passing through the superheater via the second conduit within the superheater.

50. The recirculation system of clause 49, any other suitable clause, or any combination of suitable clauses, wherein, in response to a value of an operating parameter being equal to a first threshold value, the first control valve is configured to open so as to allow the generated steam to pass through the superheater via the first conduit within the superheater and subsequently at least partially drive the first ejector.

51. The recirculation system of clause 50, any other suitable clause, or any combination of suitable clauses, wherein, in response to the value of the operating parameter being equal to a second threshold value, closing the first control valve to prevent the generated steam from passing through the first conduit within the superheater and subsequently at least partially driving the first ejector, and opening the second control valve to allow the generated steam to pass through the superheater via the second conduit within the superheater and subsequently at least partially drive the second ejector.

52. The recirculation system of clause 51, any other suitable clause, or any combination of suitable clauses, wherein the first ejector has a first size and the second ejector has a second size, wherein the first and second sizes are defined as a maximum capacity of a first amount of generated steam and second amount of anode off gas of the first and second ejectors, and wherein the second size is at least twice the first size.

53. The recirculation system of clause 52, any other suitable clause, or any combination of suitable clauses, wherein, in response to the value of the operating parameter being equal to a third threshold value, opening the first control valve to allow the generated steam to pass through the superheater via the first conduit within the superheater and subsequently at least partially drive the first ejector, and keeping open the second control valve to allow the generated steam to also pass through the superheater via the second conduit within the superheater and subsequently at least partially drive the second ejector.

54. The recirculation system of clause 53, any other suitable clause, or any combination of suitable clauses, wherein an entrainment ratio remains above 3.5 in response to the first ejector and the second ejector operating at or above a 22% load.

Moreover, the features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method for recirculating an anode off gas in a fuel cell assembly, comprising:
receiving, at a flow splitter, the anode off gas from an anode of a fuel cell;
directing, at the flow splitter, a first portion of the received anode off gas to a superheater;
superheating at the superheater, the first portion of the anode off gas and directing at least a portion of the superheated first portion to a boiler;
controlling a first flow of steam from the boiler through the superheater using a first control valve arranged between the boiler and the superheater;
controlling a second flow of steam from the boiler through the superheater using a second control valve arranged between the boiler and the superheater, wherein the first control valve fluidically connects the boiler to a first ejector downstream of the superheater, and wherein the second control valve fluidically connects the boiler to a second ejector downstream of the superheater; and
in response to a value of an operating parameter being equal to a first threshold value, opening the first control valve to allow the first flow of steam to pass through the superheater and subsequently at least partially drive the first ejector.

2. The method of claim 1, further comprising:
in response to the value of the operating parameter being equal to a second threshold value, closing the first control valve to prevent the first flow of steam from passing through the superheater and at least partially driving the first ejector, and opening the second control valve to allow the second flow of steam to pass through the superheater to at least partially drive the second ejector.

3. The method of claim 2, wherein the first ejector has a first size and the second ejector has a second size, wherein the first and second sizes are defined as a maximum capacity of a first amount of steam and second amount of anode off gas of the first and second ejectors, and wherein the second size is at least twice the first size.

4. The method of claim 3, wherein the second threshold value is equal to the first threshold value.

5. The method of claim 4, wherein the operating parameter is an average pressure of the first flow of steam and the second flow of steam, and wherein the first threshold value and the second threshold value are approximately 7.8 bar.

6. The method of claim 2, wherein the first control valve and the second control valve are electrically controlled solenoid valves.

7. The method of claim 2, further comprising:
directing, at the flow splitter, a second portion of the received anode off gas to the first ejector;
preventing the second portion of the received anode off gas from flowing back toward the flow splitter via a first check valve arranged between the first ejector and the flow splitter;
directing, at the flow splitter, a third portion of the received anode off gas to the second ejector; and
preventing the third portion of the received anode off gas from flowing back toward the flow splitter via a second check valve arranged between the second ejector and the flow splitter.

8. The method of claim 2, wherein the first flow of steam enters the superheater via a first input end of a first conduit of the superheater, increases in temperature within the superheater, exits via a first output end of the first conduit, and subsequently drives the first ejector, and wherein the second flow of steam further enters the superheater via a second input end of a second conduit of the superheater, increases in temperature within the superheater, exits via a second output end of the second conduit, and subsequently drives the second ejector.

9. The method of claim 2, wherein an entrainment ratio remains above 3.5 in response to the first ejector and the second ejector operating at or above a 22% load.

10. The method of claim 2, further comprising:
in response to the value of the operating parameter being equal to a third threshold value, opening the first control valve to allow the steam to pass through the superheater to at least partially drive the first ejector, and keeping open the second control valve to allow the steam to also pass through the superheater to at least partially drive the second ejector.

11. The method of claim 10, wherein the third threshold value is equal to the second threshold value and the first threshold value.

12. A method for recirculating an anode off gas in a fuel cell assembly, comprising:
superheating at least a portion of steam in the anode off gas in a superheater; and
in response to a value of an operating parameter being equal to a threshold value, opening a control valve configured to control a flow of steam from a boiler through the superheater to at least partially drive an ejector fluidically between the superheater and a fuel cell.

13. The method of claim 12, wherein the threshold value is a first threshold value, the control valve is a first control valve, the ejector is a first ejector, and further comprising:
in response to the value of the operating parameter being equal to a second threshold value, closing the first control valve to prevent the steam from passing through the superheater and at least partially driving the first ejector, and opening a second control valve arranged upstream of the superheater to allow the steam to pass through the superheater to at least partially drive a second ejector fluidically between the superheater and a fuel cell.

14. The method of claim 13, wherein the first ejector has a first size and the second ejector has a second size, wherein the first and second sizes are defined as a maximum capacity of a first amount of steam and second amount of anode off gas of the first and second ejectors, and wherein the second size is at least twice the first size.

15. The method of claim 14, further comprising:
in response to the value of the operating parameter being equal to a third threshold value, opening the first control valve to allow the steam to pass through the superheater and at least partially drive the first ejector, and keeping open the second control valve to allow the steam to also pass through the superheater and at least partially drive the second ejector.

16. A recirculation system for a fuel cell assembly, comprising:
a flow splitter operably coupled to an anode of the fuel cell and configured to receive an anode off gas therefrom;
a superheater disposed downstream from the flow splitter and configured to regulate a first portion of the anode off gas received through the flow splitter;
a boiler operably coupled to the superheater and configured to receive the first portion of the anode off gas, the boiler further configured to generate steam and direct at least a portion of the steam toward the superheater;
a plurality of ejectors including a first ejector and a second ejector, the first ejector arranged downstream of the superheater, the first ejector configured to be driven at least partially by a first flow of steam of the generated steam from the superheater, the second ejector arranged downstream of the superheater, the second ejector configured to be driven at least partially by a second flow of steam of the generated steam from the superheater; and
a plurality of control valves including a first control valve and a second control valve, the first control valve arranged between the boiler and the superheater, the first control valve configured to open so as to allow the first flow of steam to pass through the superheater and configured to close so as to prevent the first flow of steam from passing through the superheater, the second control valve configured to open so as to allow the second flow of steam to pass through the superheater and configured to close so as to prevent the second flow of steam from passing through the superheater,
wherein, in response to a value of an operating parameter being equal to a first threshold value, the first control valve is configured to open so as to allow the first flow of steam to pass through the superheater to at least partially drive the first ejector.

17. The recirculation system of claim 16, wherein, in response to the value of the operating parameter being equal to a second threshold value, closing the first control valve to prevent the first flow of steam from passing through the superheater and at least partially driving the first ejector, and opening the second control valve to allow the second flow of steam to pass through the superheater to at least partially drive the second ejector.

18. The recirculation system of claim 17, wherein the first ejector has a first size and the second ejector has a second size, wherein the first and second sizes are defined as a maximum capacity of a first amount of generated steam and second amount of anode off gas of the first and second ejectors, and wherein the second size is at least twice the first size.

19. The recirculation system of claim 18, wherein, in response to the value of the operating parameter being equal to a third threshold value, opening the first control valve to allow the first flow of steam to pass through the superheater to at least partially drive the first ejector, and keeping open the second control valve to allow the second flow of steam to also pass through the superheater to at least partially drive the second ejector.

20. The recirculation system of claim 19, wherein an entrainment ratio remains above 3.5 in response to the first ejector and the second ejector operating at or above a 22% load.
